(19) United States
(12) Patent Application Publication
(10) Pub. No.: US 2023/0143023 A1
(43) Pub. Date: May 11, 2023

(54) INJECTION MOLDED PARTS

(71) Applicant: DSM IP ASSETS B.V., Heerlen (NL)

(72) Inventors: Jeroen Joost CREVECOEUR, Echt (NL); Jun QIU, Echt (NL)

(21) Appl. No.: 17/913,563

(22) PCT Filed: Mar. 25, 2021
(86) PCT No.: PCT/EP2021/057809

§ 371 Date: Sep. 22, 2022

(30) Foreign Application Priority Data
Mar. 26, 2020 (EP) 20166009.9

(51) Int. Cl. B29C 45/00; B29C 48/05; C08J 3/20; C08J 5/04; B29C 71/02

(52) U.S. Cl. CPC B29C 45/0005; B29C 48/05; C08J 3/20; C08J 5/043; C08J 7/08; B29C 2045/0091; C08J 2381/04; B29K 2081/04

(57) ABSTRACT

The invention relates to an injection molded part comprising a composition comprising: a. Polyarylene sulfide (PAS) in an amount of between 50 wt % and 90 wt %; b. Glass fibers in an amount of between 10 wt % and 50 wt %; wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition. The invention further relates to a fuel cell comprising the injection molded part.

This invention relates to an injection molded part comprising a composition comprising polyarylene sulfide and glass fibers. Particularly, this invention relates to fuel cell applications comprising the injection molded part. The invention also relates to a method for preparing a composition comprising polyarylene sulfide and glass fibers and a method for preparing an injection molded part comprising said composition.

A fuel cell, and in particular proton exchange membrane fuel cell (PEMFC), is an electrochemical device that combines hydrogen fuel with oxygen to produce electricity, heat and water. Multiple fuel cells are referred to as a fuel stack. A fuel stack may comprise hundreds of individual fuel cells together with various components, made of various materials, such as for example polymer compositions and/or metal. Each individual fuel cell contains a sandwich structure of bipolar plates, gas dissipation layer and a proton exchange membrane with a platinum catalyst layer. The platinum catalyst oxidizes the hydrogen molecules, let it selectively pass hydrogen ions from an anode to a cathode and forces electrons to travel as current through an external device to the cathode. Given the nature of chemical reaction in a fuel cell, ions that leach out from materials utilized to make components for the fuel cell stack, has to be minimized and ideally prevented. Impurities and ions leaching out of the components used in the fuel cell stack may be poisoning to the catalyst and may clog up the membrane, which may significantly decrease the efficiency of the fuel cell stack and affect its life time.

Any components for fuel cells being injection molded parts, containing polyarylene sulfide and glass fibers, should exhibit low ion leaching in order to maintain efficiency of the fuel cell stack. Moreover, especially when in contact with water, these injection molded parts, should exhibit sufficient hydrolytical stability, especially at elevated temperatures. Fuel cell operating temperatures are typically between 50 and 80° C. with peak temperatures around 110° C., and this necessitates injection molded parts which combine low ion leaching in combination with sufficient hydrolytical stability, such as for example sufficient elongation at break and tensile strength, even after being exposed to water at elevated temperatures for longer periods.

The object of the present invention is to provide injection molded parts, which exhibit lower ion leaching and sufficient mechanic retention, particularly under hydrolytic environment, such as sufficient elongation at break and/or tensile strength, particularly after exposure to water or water/glycol at elevated temperatures. Surprisingly, this has been accomplished with an injection molded part comprising a composition comprising:
a. Polyarylene sulfide (PAS) in an amount of between 50 wt % and 90 wt %;
b. Glass fibers in an amount of between 10 wt % and 50 wt %;
   wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition.

US2018265701 relates to a resin composition comprising a polyarylene sulfide resin having a reduced chlorine content and a reduced sodium content and a filler. The composition, however, has a high iodine content, as the polyarylene sulfide is prepared employing iodination of benzene, and further reacting with the element sulfur, to form polyphenylene sulfide. This has as disadvantage that in this polymerization process, iodine recovery is hardly fully realized in this process, resulting in high cost of the polyarylene sulfide. Moreover, iodine moiety built-in the polymer chain and/or at the end groups, may be further active in each thermal processing of the polyarylene sulfide.

Injection molded parts are known per se and are obtained by an injection molding process, which is known to a person skilled in the art. Injection molding includes the steps of heating a composition comprising PAS to above the melting temperature of PAS to obtain a melt, filling a mold with the melt and subsequently cooling the mold and composition so that the composition solidifies into an injection molded part.

The injection molded part according to the invention comprises a composition comprising polyarylene sulfide (PAS) in an amount of between 50 wt % and 90 wt %, wherein the weight percentage is with respect to the total weight of the composition. Preferably, PAS is present in an amount of between 55 wt % and 85 wt %, more preferably between 60 wt % and 80 wt %, and most preferred between 60 wt % and 70 wt %. In a preferred embodiment, PAS is poly (p-phenylene) sulfide (PPS), as this has the advantage that PPS is readily available.

The injection molded part according to the invention comprises a composition wherein the composition has a sodium content of at most 3500 ppm, preferably at most 3000 ppm, even more preferred at most 2500 ppm and most preferred at most 2000 ppm, with respect to the total weight of the composition. Sodium content can be measured with Inductively coupled plasma atomic emission spectroscopy (ICP-AES), as described below. The sodium content of the composition may be as low as 20 ppm.

Preferably, the injection molded part according to the invention comprises a composition exhibiting a crystallization temperature (Tc) of at least 230° C., more preferably at least 235° C.; most preferred at least 240° C., which is measured by DSC according to the method of ISO 11357-1/3 (2009) with a scan rate of 10° C./min heating the composition to 320° C., and keeping the composition for 3 mins at 320° C. under nitrogen, and subsequently cooling the composition at the same scan rate to record the cooling crystallization temperature in the first cooling cycle. This has the advantage that it improves the hydrolytical stability of the injection molded part.

Preferably, the injection molded part according to the present invention comprises a PAS, more preferably PPS, having a sodium content in an amount of at most 500 ppm, more preferably, at most 400 ppm, most preferably at most 300 ppm, even more preferably at most 250 ppm, wherein ppm is with respect to the total weight of the PAS, or PPS respectively. The sodium content may be as low as 5 ppm.

The injection molded part according to the invention comprises a composition wherein the PAS is structured mainly by —(Ar—S)—, (Ar is the arylene group), as the repeating unit. Examples of the arylene group are p-phenylene group, m-phenylene group, substituted phenylene group, p,p′-diphenylene ether group, p,p′-diphenylene carbonyl group, and naphthalene group. The PAS may be polymerized by a process known to the person skilled in the art. A particularly preferred production process comprises a polymerizing step of polymerizing a sulfur source and a dihalo aromatic compound in an organic polar solvent to produce polyarylene sulfide. Said production process is disclosed for PPS by U.S. Pat. No. 3,919,177. Said production process does not generate any chain bound and/or any free iodine in the PAS. The resulting PAS, such as PPS, comprises no iodine or if present, the iodine content is below 10 ppm, preferably below 5 ppm. Low sodium content of the PAS as set out above may be achieved by acid washing. Acid washing is a procedure known per se. After the polymerization of the PAS, the PAS is preferably treated by washing with acid, washing with hot water, or washing with organic solvent, or a combination thereof, to change the end group of the PAS from —SNa to —SH. Preferably, the wash solution has a pH value of between 2 and 7, suitable wash solution may be acetic acid (CH3COOH), phosphoric acid (H3PO4), and oxalic acid (C2H2O4), or other organic acids, more preferably, acetic acid is used.

Additionally, preferably the crystallization temperature (Tc) of the PAS, preferably PPS, is at least 230° C., more preferably at least 235° C.; most preferred at least 240° C., which is measured by DSC according to the method of ISO 11357-1/3 (2009) with a scan rate of 10° C./min heating the composition to 320° C., and keeping the composition for 3 mins at 320° C. under nitrogen, and subsequently cooling the composition at the same scan rate to record the cooling crystallization temperature in the first cooling cycle, as this improves the hydrolytical stability of the injection molded part.

Preferably, the PAS has a weight average molecular weight (Mw) in the range of 10000-100000 g/mol, more preferably, in range of 20000-80000 g/mol, even more preferably, in range of 30000-80000 g/mol; most preferably, in range of 30000-70000 g/mol.

Preferably, the polyarylene sulfide suitable in present application has a PDI (weight average molecular weight/number average molecular weight; Mw/Mn) of less than 3, preferably, less than 2.5, more preferably less than 2.1.

In the context of the present invention, the molar mass of the polyarylene sulfide was determined according to the general guidelines for SEC analysis which were followed according to ASTM D5296-06, by means of high-temperature Size-Exclusion Chromatography. The PAS (or where applicable, PPS) samples were dissolved in 1-chloronaphthalene at approximately 2 mg/ml at 230° C. Agilent PL-GPC 220 chromatograph with differential refractive index (RI), differential viscometer (DV) and double angle light-scattering detector operating at the scattering angles of 15° and 90° were used. do/dc for PPS in 1-chloronaphthalene of 0.167 was applied in light scattering data calculations. Three Polymer Laboratories PLgel Mixed-B, 300×7.5 mm columns with particle size of 10 μm were applied in polymer separation. Injection volume of the polymer solution was equal to 200 μl. Eluent used was 1-chloronaphthalene with 100 ppm DBPC (BHT). The analysis temperature was set to 210° C. and a flow rate of 1 ml/min was applied. The molar mass was calculated with triple approach in which light scattering detector was calibrated with well-defined, linear sample. The latter was also used to measure multi-detector offsets.

The linearity of PAS suitably in present application has Mark-Houwink parameter of 0.70±0.03, which is taught and determined by C. J. Stacy, Molecular weight distribution of polyphenylene sulfide by high temperature gel permeation chromatography, Journal of Applied Polymer Science, 32 (1986) 3, pp 3959-3969.

The PAS, preferably the PPS, preferably has a melt flow of between 50 and 1000 g/10 min, preferably between 150 and 1000 g/10 min, more preferably between 200 and 800 g/10 min and most preferred between 300 and 600 g/10 min as determined by method of ISO1133 as measured with 5 kg at 316° C.

The injection molded part comprising a composition according to the invention comprises glass fibers in an amount of between 10 wt % and 50 wt % wherein the weight percentage is with respect to the total weight of the composition. “Glass fibers” are herein understood to be glass particles having an aspect ratio L/D, defined as the average ratio between the length (L) and the largest of the width and thickness (D) of at least 5. Preferably, the aspect ratio of the glass fibers is at least 10, more preferably at least 20. Suitable glass fiber has approximately 6 to 25 μm diameter. Glass fibers generally have a length of between 1 and 10 mm, and a diameter of between 6 and 15 um, and may have a flat shape and non-circular cross-sectional area, where the width of the major cross-sectional axis of this is in the range from 6 to 40 um and the width of the minor cross-sectional axis of this is in the range from 3 to 20 um. The glass fiber is preferably selected from the group of the E-glass fibers. A glass fibers, C glass fibers, D glass fibers, S glass fibers and/or R glass fibers. Particularly suitable are glass fibers such as DS8800-11P 4 mm, available from 3B.

Preferably, glass fibers are present in an amount of between 20 wt % and 45 wt %, more preferably between 20 wt % and 40 wt %, and even more preferably between 25 wt % and 40 wt %, and most preferred between 30 wt % and 40 wt %, wherein the weight percentage is with respect to the total weight of the composition. Preferably, the glass fibers have a sodium content of less than 5000 ppm with respect to the total weight of the glass fibers as measured by ICP-AES. Preferably, the glass fibers have a sodium content of at most 3000 ppm, more preferred at most 1000 ppm, even more preferred at most 800 ppm, wherein ppm is with respect to the total weight of the glass fibers. The minimum sodium content may be as low as 50 ppm.

The form in which the glass fibers are present in the composition may be that of continuous-filament fibers or that of chopped or ground glass fibers. The fibers may comprise a suitable size system, preferably comprising inter alia coupling agents in particular based on silanes. Suitable silanes for example include γ-aminopropyltriethoxysilane, γ-aminopropyltrimethoxysilane, γ-aminopropylmethyldiethoxysilane, γ-aminopropylmethyldimethoxysilane, N-β(aminoethyl)-γ-aminopropyltriethoxysilane,N-β(aminoethyl)-γ-aminopropyl-trimathoxysilane, N-β(aminoethyl)-yaminopropylmethyldiethoxysilane, N-β(aminoethyl)-γ-aminopropylmethyldimethoxysilane, N-phenyl-γ-aminopropyltriethoxysilane and N-phenyl-γ-aminopropyltrimethoxysilane, preferably, the aminoalkoxylsilane is γ-aminopropyltriethoxysilane and/or γ-aminopropyltrimethoxysilane.

The injection molding part comprises a composition comprising:
a. Polyarylene sulfide (PAS) in an amount of between 50 wt % and 90 wt %;
b. Glass fibers in an amount of between 10 wt % and 50 wt %;
   wherein the weight percentage is with respect to the total weight of the composition; and wherein the composition has a sodium content of at most 3500 ppm as measured by ICP-AES. The sodium content of the composition preferably is at most 3000 ppm, more preferably at most 2500 ppm, and even more preferred at most 2000 ppm. The sodium content of the composition may be as low as 20 ppm.

The sodium content in the PAS, in the compounded composition, or in the injection molding part is measured with ICP-AES by the following method:

A sample is prepared via an ash residue method since Sodium stays stable during combustion.
Step 1: ˜5 gram of sample is weighted accurately in a ceramic crucible and slowly combusted using a Bunsen burner. The combusted residue is then placed in a muffle furnace at 600° C. for 3 hours to ensure a full incineration. The crucible is weighted again to quantify the ash content since the ash percentage is used for recalculation of the actual Sodium concentration in the original sample.
Step 2: ˜1 gr of the ash residue is fused at 1250° C. with 5 gr Lithium metaborate using Platina labware; weighted amounts are both accurately weighted.
Step 3: ˜1 gram of the fused material, accurately weighted, is subsequently dissolved in 10 ml H₂SO₄ and 10 ml H₂O using a shaking table for 16 h.
Step 4: The dissolved solution is further diluted with H₂O till 100 ml.
Step 5: The obtained solution is analyzed by means of ICP-AES using an iCAP6500 spectrometer from Thermo Scientific. Measurements are performed against a calibration line which is prepared with certified Specpure® reference solutions from Alfa Aesar.

The injection molding part comprises a composition, which composition has a iodine content of at most 100 ppm as measured by X-ray fluorescence (XRF). Preferably, the iodine content is at most 80 ppm, more preferred at most 70 ppm and most preferred at most 50 ppm. The iodine content of the composition may be very low, and thus lower than the detection limit of the XRF method, which lies usually around 20 ppm.

Iodine content is measured by X-ray fluorescence (XRF). Since Iodine is not measurable via a sample combustion method due to its instability, Iodine is analyzed directly in the original polymer as such or in the composition via XRF analysis. A part such as flat plaque, such as a tensile bar, is punched in such way that the bottom of the measuring cup is covered totally (diameter 40 mm, 4 mm thick). The plaque is then analyzed by means of XRF using a AXIOS mAX Advanced WDXRF spectrometer from Panalytical equipped with a Rh X-ray tube. A reference sample is co-analyzed to confirm the correct locations of the iodine signals.

In a preferred embodiment, the injection molding part comprises a composition further comprising a coupling agent in an amount of between 0.1 wt % and 1.0 wt %, with respect to the total weight of the composition. Surprisingly, this leads to further improved hydrolytical stability of the composition.

Coupling agents are known per se and have the general formula (I):

(X—(CH2)ₓ)_{y}—Si—(O—CₙH₍₂ₙ₊₁₎)_{(4-y)} Formula (I)

in which the definitions of the substituents are as follows:

### X is NH2.

x is an integer from 1 to 10, preferably 2 or 3;
y is an integer from 0 to 3, preferably 0, or 3;
n is an integer from 1 to 3, preferably 1 or 2.

Suitable coupling agents include for example γ-aminopropyltriethoxysilane, γ-aminopropyltrimethoxysilane, γ-aminopropylmethyldiethoxysilane, γ-aminopropylmethyldimethoxysilane, N-β(aminoethyl)-γ-aminopropyltriethoxysilane,N-β(aminoethyl)-γ-aminopropyl-trimathoxysilane, N-β(aminoethyl)-yaminopropylmethyldiethoxysilane, N-β(aminoethyl)-γ-aminopropylmethyldimethoxysilane, N-phenyl-γ-aminopropyltriethoxysilane and N-phenyl-γ-aminopropyltrimethoxysilane, preferably, the aminoalkoxylsilane is γ-aminopropyltriethoxysilane and/or γ-aminopropyltrimethoxysilane. The coupling agent may be dosed while preparing the composition, which is usually done by compounding in an extruder. Preferably the coupling agent is dosed at a side feed together with glass fibers. Other suitable coupling agents are for example ureidopropyltrimethoxysilane or ureidopropyltriethoxysilane, as disclosed in US2015/0166731A1. Surprisingly, addition of coupling agents leads to a composition exhibiting further hydrolytic stability.

The invention also relates to a fuel cell comprising the injection molded part according to any of the embodiments disclosed above. These injection molded parts include for example, but are not limited to media distribution plates, manifolds, insulation plates, media connectors, air flow control valves, air flow breakers, hydrogen injectors, hydrogen supply valves, hydrogen regulation valves, pressure control valves, hydrogen circulation pumps, humidifiers, thermostats, electrical control cooling valves, electrical control coolant pumps.

One embodiment of the invention relates to an injection molded part as disclosed above, wherein the composition exhibits a tensile strength on an injection molded tensile bar with 4 mm thickness of at least 170 MPa, measured according to ISO 527-1A 5 mm/min at 23° C., after an exposure to water glycol (W/G) mixture (50%/50% vol. %/vol. %) at a temperature of 135° C. during 1000 hours, preferably at least 175 MPa, more preferred at least 180 MPa. In another embodiment, the invention relates to an injection molded part as disclosed above, wherein the composition exhibits a elongation at break on an injection molded tensile bar with 4 mm thickness of at least 1.5%, measured according to ISO 527-1A 5 mm/min at 23° C., after an exposure to water glycol (W/G) mixture (50%/50% vol. %/vol. %) at a temperature of 135° C. during 1000 hours, preferably at least 1.6%, more preferably at least 1.7%. In a preferred embodiment, the injection molded part exhibits a combination of tensile strength and elongation at break as disclosed above. All individual ranges are explicitly combinable. Surprisingly, the injection molded part combines sufficient tensile strength as well as elongation at break after exposure to water/glycol at elevated temperatures, while leaching of ions is reduced. This allows for applications particularly in which the injection molded part may be in contact with water containing fluids.

In a preferred embodiment, the invention relates to an injection molded part as disclosed above, wherein the composition exhibits a tensile strength on an injection molded tensile bar with 4 mm thickness of at least 160 MPa, measured according to ISO 527-1A 5 mm/min at 23° C., after an exposure to water vapor in an autoclave at a temperature of 110° C. during 1000 hours, preferably at least 165 MPa, more preferred at least 170 MPa. In another embodiment, the invention relates to an injection molded part as disclosed above, wherein the composition exhibits a elongation at break on an injection molded tensile bar with 4 mm thickness of at least 1.2%, measured according to ISO 527-1A 5 mm/min at 23° C., after an exposure to water at a temperature of 110° C. during 1000 hours, preferably at least 1.3%, more preferably at least 1.4% even more preferred at least 1.5% and most preferred at least 1.6%. In a preferred embodiment, the injection molded part exhibits a combination of tensile strength and elongation at break as disclosed above. All individual ranges are explicitly combinable. In fuel cell applications, injection molded parts may be in contact with water at elevated temperatures, and surprisingly, the injection molded parts according to the invention exhibit sufficient elongation at break and tensile strength, while leaching of ions is reduced.

The invention further relates to a method for preparing a composition comprising polyarylene sulfide and glass fibers, wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition, comprising the steps of heating the PAS to a temperature above its melting temperature, for example with an extruder, and subsequently adding glass fibers to obtain a mixture, after which the mixture is cooled and may be suitably pelletized. Preferably, if the composition further comprises a coupling agent, the coupling agent is dosed to the PAS at a side feed together with glass fibers, more preferably the coupling agent being aminoalkoxylsilane, γ-aminopropyltriethoxysilane and/or γ-aminopropyltrimethoxysilane. All preferred ranges as disclosed above are also applicable to the method for preparing the composition.

The invention also relates to a composition comprising:
a. Polyarylene sulfide (PAS) in an amount of between 50 wt % and 90 wt %;
b. Glass fibers in an amount of between 10 wt % and 50 wt %;
   wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition. All preferred ranges as disclosed above for the injection molded part comprising the composition, are also applicable to the invention relating to the composition.

### EXAMPLES

### Materials Used:

### Glass Fibers:

NEG ECS03T-747H/R, available from NEG, with a sodium content of 4500 ppm with respect to the glass fiber. Iodine content was below the detection limit.
DS8800-11P 4 mm, available from 3B, with a sodium content of 400 ppm with respect to the glass fiber. Iodine content was below the detection limit.

### PPS:

PPS A and PPS 1 were produced in accordance to the process as described in U.S. Pat. No. 3,919,177. In this process, para-dichlorobenzene was reacted with NaHS in N-methyl-2-pyrrolidone solvent under high temperature about 250° C. till the desired Mw was reached. PPS 1 was further subjected to a washing step after polymerization with water at a temperature of 80° C. to lower the amount of —SNa end groups by partially converting them to —SH, which led to the low sodium content.
The molecular characteristics, the crystallization temperatures, the sodium and iodine contents of PPS A and PPS 1 were determined according to the methods as described in the specification above.
The results are indicated below.

| | Mₙ | M_{w} | M_{z} | M_{w}/Mₙ | M_{z}/M_{w} | Tc |
|---|---|---|---|---|---|---|
| Sample | (g/mol) | (g/mol) | (g/mol) | (—) | (—) | (° C.) |
| PPS A | 20000 | 41000 | 64000 | 2.1 | 1.6 | 230 |
| PPS 1 | 30700 | 49300 | 71200 | 1.6 | 1.4 | 240 |

PPS A with a sodium content of 1500 ppm, which is 0.15 wt % with respect to the total weight of the PPS.
PPS 1 with a sodium content of 400 ppm.
PPS A and PPS 1 have a iodine content below the detection limit.
Comparative material B: A504X90 (C) available from Toray. It contains PPS with a sodium content of 1700 ppm, based on the total weight of the PPS and 40 wt % glass fibers. Iodine content of Comparative material B is below the detection limit.
Comparative material C: 1140L4 available from Celanese. This composition contains 40 wt % of glass fiber and has a sodium content of 0.47 wt % (4700 ppm) based on the total weight of the composition. Iodine content of Comparative material C is below the detection limit.

TABLE 1
compositions

| | | | | Total sodium |
|---|---|---|---|---|
| | Type of glass fiber | Type of PPS - | Coupling agent | content of |
| | and amount [wt % | and amount [wt % | and amount [wt % | composition [ppm |
| | with respect to | with respect to | with respect to | with respect to |
| | composition] | composition] | composition] | composition] |
| Comparative A | NEG ECS03T- | PPS A | (3-Aminopropyl)tri- | 3700 |
| | 747H/R | 59.5 wt % | ethoxysilane | |
| | 40 wt % | | 0.5 wt % | |
| Comparative B | 40 wt % | | | 4100 |
| Comparative C | 40 wt % | | | 4700 |
| Example 1 | DS8800-11P | PPS 1 | (3-Aminopropyl)tri- | 1000 |
| | 4 mm | 59.5 wt % | ethoxysilane | |
| | 40 wt % | | 0.5 wt % | |

The compositions were prepared by mixing the ingredients as present in Table 1, except for Comparative B which was obtained from Toray, and Comparative C, which was obtained from Celanese.

A mixture of PPS and coupling agent was combined with glass fibers, to avoid breakage of the glass fibers, and melt compounded using a twin screw extruder at temperatures of from about 315° C. to about 420° C. The molten composition was extruded into strands and passed through a water bath prior to being chopped into pellets. The resulting pellets were dried at 140° C. for at least 4 hours, and were then molded into test articles testing for example e.g. tensile strength testing, tensile modulus testing, tensile strain testing by injection molding at melt temperatures of 315° C. to 345° C. with mold cavity surface temperatures of 135° C. to 150° C.

All tensile testing in the case of Tables 2 were conducted in accordance with standard test methods ISO 527-2. The test articles were subjected to tensile testing to obtain initial property values (TO hours values), and the data are displayed in Tables 2-1 to 2-6. Test articles were subjected to water glycol (W/G) mixture (50%/50% vol. %/vol. %). W/G aging of the test articles was conducted by fully immersing the test articles (e.g., molded test specimens) in W/G within a closed stainless steel pressure vessel heated to 135±2° C. using the steam heating, over various time periods (e.g., 1 week, 2 weeks, and 6 weeks), as noted in Tables 2-1 to 2-3, to yield aged test articles. The aged test articles were then recovered and subjected to tensile testing to obtain final property values, and the data are displayed in Tables 2-1 to 2-3 (tensile properties, aged at 135° C., tested at 23° C.). “n.m.” in the tables stands for not measured.

TABLE 2-1
Tensile test ISO 527-1A 5 mm/min, @ 23° C. - Tensile-Modulus

| | Tensile-Modulus (MPa) (Ageing hrs @ 135° C.) | | | |
|---|---|---|---|---|
| | T0 | 168 hours | 336 hours | 6 weeks |
| Comparative A | 14745 | 15278 | 15136 | 14884 |
| Comparative B | 15276 | 14373 | 14400 | n.m. |
| Example 1 | 14659 | 14863 | 14865 | 14376 |

TABLE 2-2
Tensile test ISO 527-1A 5 mm/min, @ 23° C. - Tensile strength

| | TS (MPa) (Ageing hrs @ 135° C.) | | | |
|---|---|---|---|---|
| | T0 | 168 hours | 336 hours | 1008 hours |
| Comparative A | 191 | 175 | 172 | 158 |
| Comparative B | 184 | 148 | 137 | n.m. |
| Example 1 | 203 | 190 | 193 | 188 |

TABLE 2-3
Tensile test ISO 527-1A 5 mm/min, @ 23°
C. - Elongation at break (eab)

| | eab % (Ageing hrs @ 135° C.) | | | |
|---|---|---|---|---|
| | T0 | 168 hours | 336 hours | 1008 hours |
| Comparative A | 1.84 | 1.46 | 1.44 | 1.3 |
| Comparative B | 1.61 | 1.24 | 1.15 | n.m. |
| Example 1 | 2.26 | 1.84 | 1.94 | 1.88 |

### Autoclave Ageing A 110° C.

The test articles were subjected to tensile testing to obtain initial property values, referred to as T0 in the tables, and the data are displayed in Table 2-4 to 2-6. Test articles were subjected to water steam @ 110° C. in an autoclave, over various time periods namely after 500 hours and 1000 hours, as noted in Table 2-4 to 2-6, to yield aged test articles. The aged test articles were then recovered and subjected to tensile testing to obtain final property values, and the data are displayed in Table 2-4 to 2-6 showing tensile properties, aged at 110° C. and measured at 23° C.

TABLE 2-4
Tensile test ISO 527-1A 5 mm/min, measured @ 23°
C. - Tensile-Modulus

| | Tensile modulus (MPa) (Ageing hrs @ 110° C.) | | |
|---|---|---|---|
| | T0 | 500 hrs | 1000 hrs |
| Comparative A | 15135 | 14414 | 15001 |
| Comparative C | 15236 | 14034 | 14431 |
| Example 1 | 14659 | 14527 | 14061 |

TABLE 2-5
Tensile test ISO 527-1A 5 mm/min, measured @ 23°
C. - Tensile strength

| | TS (MPa) (Ageing hrs @ 110° C.) | | |
|---|---|---|---|
| | T0 | 500 hrs | 1000 hrs |
| Comparative A | 198 | 151 | 157 |
| Comparative C | 188 | 123 | 109 |
| Example 1 | 203 | 173 | 175 |

TABLE 2-6
Tensile test ISO 527-1A 5 mm/min, measured @ 23° C. - eab

| | eab % (Ageing hrs @ 110° C.) | | |
|---|---|---|---|
| | T0 | 500 hrs | 1000 hrs |
| Comparative A | 1.69 | 1.20 | 1.16 |
| Comparative C | 1.66 | 1.00 | 0.90 |
| Example 1 | 2.26 | 1.60 | 1.70 |

Tables 2-1 to 2-3 clearly show that the E-modulus of the various samples is similar. Tensile strength and EAB are highest for Example 1, and also remain higher after prolonged exposure to W/G. Comparative B showed a dramatic decrease for tensile strength and EAB, that these were no longer measured after 1008 hours.
Tables 2-4 to 2-6 show that the E-modulus of the various samples is similar. Also here, Tensile strength and EAB are highest for Example 1, and also remain higher after prolonged exposure to water steam. Comparative A and C showed a dramatic decrease for tensile strength and EAB, in contrast to Example 1, for which the values were still sufficient, even after 1000 hours.

### Leaching Experiments

### Sample Information

Three compositions were used for the leaching experiments as tensile bars, namely Comparative A, Comparative B and Example 1, as described in Table 1. Test specimen of ½ tensile bar were used. The test specimen had the following properties; 4.0 mm thick, total surface area 32 cm². ISO527-1A was used for the test specimen.

### Leaching Incubation Protocol:

1) Specimen was put in 100 ml of ultrapure water (=32 mm²/ml);
2) Oven aging at 90° C. in closed Teflon™ FEB bottle;
3) Incubation for 6 weeks @ 90° C., the 100 ml was subjective to ICP-AES measurement, a reference sample with Blanco incubation of 100 ml in Teflon bottle included as well.

### ICP-AES Analysis Set-Up for Leaching Results

˜15 ml of liquid was sampled for the ICP-AES screening, The samples were acidified with 0.5 ml HNO₃ prior to the measurements. A quantitative multi-element screening was performed with a certified reference standard. Measurements were performed with an iCAP6500 ICP-AES from Thermo Scientific. The main 5 leaching elements of Si, Ca, Al, K, and Na are presented in Table 3. Significant differences in leaching behavior were observed between the different PPS samples.

TABLE 3
Leaching results

| | Concentration of element (mg/kg) | | | | |
|---|---|---|---|---|---|
| | Si | Ca | Al | Mg | Na |
| Comparative A | 8.49 | 5.62 | 2.18 | 0.33 | 0.33 |
| Comparative B | 10 | 6.78 | 2.46 | 0.38 | 0.25 |
| Example 1 | 1.65 | 0.97 | 0.04 | 0.1 | 0.01 |
| Blanco (Ref.) | 0.02 | <0.01 | <0.01 | <0.01 | <0.01 |

Comparative B clearly showed worst leaching performance over all reported elements, closely followed by Comparative A. Example 1 clearly exhibited lowest leaching content over all reported elements.

1. Injection molded part comprising a composition comprising:
a. Polyarylene sulfide (PAS) in an amount of between 50 wt % and 90 wt %;
b. Glass fibers in an amount of between 10 wt % and 50 wt %;
wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition.

2. Injection molded part according to claim 1, wherein the amount of PAS is between 60 wt % and 80 wt %, and the amount of glass fibers is between 20 wt % and 40 wt %, wherein the weight percentage is with respect to the total weight of the composition.

3. Injection molded part according to claim 1, wherein the composition has a sodium content of at most 2000 ppm as measured by Inductively coupled plasma atomic emission spectroscopy (ICP-AES)

4. Injection molded part according to claim 1, wherein the PAS has a sodium content of at most 500 ppm with respect to the total weight of the PAS.

5. Injection molded part, according to claim 1, wherein the glass fibers have a sodium content of at most 3000 ppm with respect to the total weight of the glass fiber.

6. Injection molded part according to claim 1, wherein the glass fibers have a sodium content of at most 800 ppm with respect to the total weight of the glass fiber.

7. Injection molded part according to claim 1, wherein the PAS has a crystallization temperature of at least 230° C. measured by DSC according to the method of ISO 11357-1/3 (2009) with a scan rate of 10° C./min heating the composition to 320° C., and keeping the composition for 3 mins at 320° C. under nitrogen, and subsequently cooling the composition at the same scan rate to record the cooling crystallization temperature in the first cooling cycle.

8. Injection molded part according to claim 1, wherein the composition has a tensile strength on an injection molded tensile bar with 4 mm thickness of at least 160 MPa, measured according to ISO 527-1A 5 mm/min at 23° C., after an exposure to water vapor in an autoclave at a temperature of 110° C. during 1000 hours, preferably at least 165 MPa, more preferred at least 170 MPa.

9. Injection molded part according to claim 1, wherein the composition has an elongation at break on an injection molded tensile bar with 4 mm thickness of at least 1.2%, measured according to ISO 527-1A 5 mm/min at 23° C., after an exposure to water vapor in an autoclave at a temperature of 110° C. during 1000 hours, preferably at least 1.3%, more preferably at least 1.4% even more preferred at least 1.5% and most preferred at least 1.6%.

10. Injection molded part according to claim 1, wherein the polyarylene sulfide is polyphenylene sulfide.

11. Injection molded part according to claim 1, wherein the composition further comprises a coupling agent in an amount of between 0.1 wt % and 1.0 wt %, with respect to the total weight of the composition.

12. Injection molded part according to claim 11, wherein the coupling agent is aminoalkoxylsilane, γ-aminopropyltriethoxysilane and/or γ-aminopropyltrimethoxysilane.

13. Fuel cell comprising the injection molded part according to claim 1.

14. Method for preparing a composition comprising polyarylene sulfide and glass fibers, wherein the composition has a sodium content of at most 3500 ppm as measured by Inductively coupled plasma atomic emission spectroscopy (ICP-AES) and wherein the composition has a iodine content of at most 100 ppm as measured by X-ray fluorescence (XRF) and wherein the weight percentage and ppm is with respect to the total weight of the composition, comprising the steps of heating the PAS to a temperature above its melting temperature, for example with an extruder, and subsequently adding glass fibers to obtain a mixture, after which the mixture is cooled and may be suitably pelletized.

15. Method according to claim 14, wherein a coupling agent being aminoalkoxylsilane, γ-aminopropyltriethoxysilane and/or γ-aminopropyltrimethoxysilane is dosed to the PAS together with the glass fibers.
